(19) United States
(12) Patent Application Publication
(10) Pub. No.: US 2013/0030333 A1
(43) Pub. Date: Jan. 31, 2013

(54) Manual CPR apparatus with force multiplier

(71) Applicants: Chris W. Cicenas, Pataskala, OH (US); Thomas E. Lach, Columbus, OH (US)

(72) Inventors: Chris W. Cicenas, Pataskala, OH (US); Thomas E. Lach, Columbus, OH (US)

(21) Appl. No.: 13/136,260

(22) Filed: Jul. 27, 2011

(51) Int. Cl. A61H 31/00

(52) U.S. Cl. 601/41

(57) ABSTRACT

A manual CPR apparatus for increasing the flow of blood in a patient suffering cardiac arrest. A force multiplier mounts to a base contoured to seat near a central region of the patient's chest. The force multiplier connects to a manual actuator and belt connectors which, in turn, connect to opposite ends of a substantially inelastic belt wrapped around the patient's chest. The force multiplier doubles the force manually applied to the actuator and directs it through the base toward the chest. The force multiplier includes two assemblies. The first has a pair of arms rigidly connected in the same plane to a trolley assembly and two grippable handles extending perpendicularly from either side of the trolley assembly. The second assembly has a pair of vertical struts that attach to opposite sides of the base on either side of the pair of arms of the first assembly.

### CROSS REFERENCE TO RELATED APPLICATIONS

The present application claims the priority of the PCT application PCT/US2010/000638 filed on Feb. 27, 2010, which, in turn, claimed the priority of the filing of the U.S. provisional patent application 61/208,849 filed on Feb. 27, 2009, of which the present application also claims the priority and the design patent application entitled CPR APPARATUS with the inventors Christopher R. Boggs, Jeffrey R. Burger, Chris W. Cicenas and Thomas E. Lach, Case D24-14, filed on Feb. 27, 2009, the disclosures of all of which are incorporated here.

### STATEMENT REGARDING FEDERALLY SPONSORED RESEARCH OR DEVELOPMENT

This invention was made under a contract with an agency of the United States government. The name of the U.S. agency and the government contract number are: National Institute of Health contract number R41 HL071378

### BACKGROUND

K. A. Kelly et al., in their U.S. Pat. No. 5,738,637, issued Apr. 14, 1998, U.S. Pat. No. 6,234,984, issued May 22, 2001, U.S. Pat. No. 6,325,771, issued Dec. 4, 2001, U.S. Pat. No. 6,645,163, issued Nov. 11, 2003, and U.S. Pat. No. 7,186,225, issued on Mar. 6, 2007, as well as their U.S. patent application Ser. No. 9/818,102, filed Mar. 27, 2001, have provided a remarkable manual device for effectuating CPR on a patient suffering cardiac arrest. Further, T. E. Lach, in his U.S. patent application Ser. No. 12/004,004 filed on Dec. 19, 2007, has provided a useful device of effectuating the CPR along the lines of the patents and application referenced above but in a more facile manner alongside the patient suffering cardiac arrest. The disclosures of these patents and applications are incorporated here by reference. The CPR device of Kelly et al. permits the quick, correct, facile and reliable, manual application of CPR to a person suffering cardiac arrest. The advance of Lach's mechanism permits the operator of the CPR device to kneel on the side of the patient, orient his or her hands along the longitudinal axis of the patient, but carry out the CPR of Kelly et al.'s mechanism.

Substantial interest has focused on the ready use of defibrillation on persons suffering from cardiac arrest. While this process has a significant place in the treatment of such persons, it does not aid in bringing oxygen to the heart so that it can function upon defibrillation.

The manual CPR apparatus shown in the Kelly et al. patents and application and in Lach's application facilely accomplish both types of circulation assistance. It allows the downward force placed on it to pass directly into the chest of the patient to effectuate the radial force that directly depresses the chest. However, it also tightens a belt placed around the patient's chest to constrict it and the patient's chest to achieve further and important circulation around the heart muscle.

Significantly, the device of Kelly et al. or that of Lach requires a minimal financial investment and virtually no training. This allows their placement in many and varied locations, such as the trunks of police squad cars and at gymnasiums and its use by individuals, such as the police themselves and others like coaches and other institutional personnel. In its simplest form, this CPR apparatus utilizes a belt placed around the victim and attached to a mechanism. When the operator pushes down on the handles forming part of this mechanism, some of the downward force passes straight through to the patient in the form of a radial force directed inward from his or her sternum into the chest. The device also converts part of the applied downward force into a tangential component that effects a circumferential tightening of the belt around the chest to squeeze it and further promote blood circulation around the heart.

As a further safety feature, the apparatus may include a device for limiting the amount of circumferential tightening applied to the patient's chest. In particular, this feature may allow a choice between several different forces applied around the chest.

To assure full chest expansion between down strokes, Kelly et al.'s and Lach's devices may incorporate a component on its chest-contacting surface for adhering the device to the chest. Upon the release of pressure, this adherence will assist to expand the chest by pulling up on the patient's torso. This adhering device may take the form of suction cups or even some form of adhesive.

Kelly et al. and Lach also suggest a signal generator forming part of their device. This component has the purpose of producing a periodic signal. This signal simply informs the operator when to push down on the apparatus and helps achieve a rhythmic application of force at the interval that portends the greatest positive effect on the patient.

In either situation, the apparatus may also include two or more electrodes, spaced apart from each other, that contact the patient's chest at different locations. Two electrodes may attach to the base of the device which sits on the chest. Alternately, one may attach to the base while a second connects to the belt. Or, the two may attach at different locations along the longitudinal axis of the device's belt. Or, with more, the electrodes may attach to the belt and at several locations around the belt.

The electrodes may serve to obtain an electrocardiogram of the patient. Alternately or additionally, the electrode may defibrillate the heart when necessary.

As seen from the above, the Kelly et al. and Lach devices have provided vastly improve CPR to individuals in dire need of such treatment. Naturally, the work continues to improve these mechanisms even further.

### SUMMARY

An improved apparatus for increasing the flow of blood in a patient will typically include a base contoured to seat near a central region of a patient's chest, and a force delivery device coupled to the base. A handle coupled to the force delivery device in a manner that allows the handle to travels over a range of motion towards and away from the patient's chest. A substantially inelastic belt passes around the patient in the region of his or her chest and maintains the base in a position on the patient's chest. A belt securing assembly couples to said force delivery device and the belt means to secure the belt to the force delivery device.

Under this arrangement, the force delivery device, when the handle moves a distance towards the patient's chest, moves the base towards the chest at an approximately constant fraction of the distance traveled by the handle over its range of motion. In particular, this fraction is unequal to one so that the handle and the base move over different distances from each other. As a good example, this fraction may amount to about one half, which means that the base travels half of the distance that the handle moves.

Alternately, a first force of a first magnitude may be applied to the handle towards the base. Then, the force delivery device applies a second force of a second magnitude of about a substantially constant multiplier of said first magnitude to the base towards the chest over the range of motion of the handle. This multiplier should not equal one. Typically, it may amount to two. This means that the base imposes a force of about twice the magnitude of the force that the operator applies to the handle.

In either case described above or in general, the handle may move in a substantially straight line towards and away from the chest. Typically, this will means in the vertical direction. Further, in this situation, the force delivery device limits the travel of the handle in the straight line. This force delivery device also may vary the limit the distance that the handle travels towards the chest or away from it. The latter may prove more propitious since it does not have to suffer the downward force of the handle attempting to compress the patient's chest.

As a further possibility, the force delivery device, upon the application of a first force of a first magnitude to the handle towards said base, applies a second force with a resultant vector direction substantially parallel to the first force. The second force may have a second magnitude greater than said first magnitude and is directed to the base towards the patient's chest over the range of motion of the handle.

In a CPR apparatus of the general type described above, the base and the force delivery device have a connecting device between them. This connecting device may permit relative motion between these two components and, in particular, rotational motion in a plane passing vertically though the longitudinal central axis of the patient's body.

The belt in a CPR device may have first and second ends and pass around the patient in the region of the patient's chest. The belt securing assembly then secures the belt to the force delivery device. In particular, the securing assembly may attaches at any point within a predetermined distance of the first end of the belt. While the belt securing assembly is coupled to the belt, it permits motion of the first end of the belt in a direction to tighten the belt around the patient. Yet, it prohibits motion of the first belt end in a direction to loosen belt around the patient.

In particular, the belt may take the form, near its first end, of a substantially stiff, wide belt. The belt securing assembly, in turn, may have a U-shaped configuration which allows the first end of the belt to enter the opening of the U shape. When the first end of the belt has thus has entered the opening of the U shape, the belt securing assembly may prohibit the first end from moving in a direction to loosen the belt around the patient. As one way to accomplish this objective, the belt securing assembly may include a gripping device on at least one side of and coupled to the U shape to prevent movement of the belt in the direction to loosen the belt around the patient. Yet, it still allows movement of the belt in the direction to tighten the belt around the patient.

Treating a patient with CPR involves first seating a base of a blood flow increasing apparatus near a central region of the patient's chest. A handle couples to the base and travels over a range of motion towards and away from the chest. Lastly, the base is moved towards the chest at an approximately constant fraction of the distance traveled by the handle over said its range of motion. This fraction should not equal the number one in order to accomplish a force magnifying effect. Making the fraction equal to one half may double the force applied to the chest compared to that applied to the handle.

An alternate manner of stating the foregoing objective involves moving the handle with a first force of a first magnitude over a range of motion towards and away from the chest. A second force of a second magnitude is then applied to the base in a direction towards the chest. The second magnitude has a substantially constant multiplier of the first magnitude as the handle moves over its range of motion towards the base. This multiplier must remain unequal to the number one. In particular, the number two for this multiplier will result in a doubling of the force applied to the handle reaching the patient's chest. This method may also propitiously include moving the handle in a substantially straight line over its range of motion.

Alternately, the second force may having a resultant vector direction substantially parallel to the first force. It will typically also have a second magnitude greater than the first magnitude and be directed to the base towards the chest over the range of motion of the handle.

The CPR method may again involve moving the handle in a substantially straight, and preferably vertical, line towards and away from the patient's chest. The base, in this instance, may remain in contact the patient's chest with the bottom of the base lying flat on the chest as the chest changes its orientation during CPR. This relationship of the base lying flat on the base appears to benefit the CPR process.

The process of CPR may actually commence with placing a belt under the patient with one unattached to the blood flow increasing apparatus. This typically means sliding an unattached belt end under the patient. The free end of the belt is then attached to a belt securing apparatus at any point within a predetermined distance from the free end of the belt. The free end is then pulled to tighten the belt around the patient while the belt securing assembly prevents motion of the belt in a direction that would allow the belt to loosen about the patient. This process is substantially aided by using a flat, wide, substantially stiff belt.

The belt may take the form, near one end, of a substantially stiff, wide stiff section of material. The belt securing assembly has a U-shaped configuration which allows the first end of the belt to enter its opening. The end of the belt is attached by placing it into the opening of the U shape. Pulling the belt in a direction away from the patient while the belt end remains within the opening of the U shape tightens the belt around the patient.

### BRIEF DESCRIPTION OF THE FIGURES

FIG. 1 gives a front elevational view of a CPR apparatus operated by an attendant on a patient

FIG. 2 provides a perspective view of the CPR apparatus of FIG. 1 but without the operator or the patient.

FIG. 3a illustrates, in an end view, the CPR apparatus of the prior figures in its extended configuration on a patient shown in cross section.

FIG. 3b shows the CPR apparatus FIG. 3a but in its depressed configuration.

FIG. 4 gives an end view of a CPR apparatus very similar to that of the prior figures but where the belt passes through openings in a backboard.

FIG. 5 provides an end view of a CPR apparatus similar to that in FIG. 4 but where pieces of the belt attach to the backboard which thus forms part of the belt itself.

FIG. 6 gives an exploded view of the CPR mechanism of the prior figures.

FIG. 7 provides a greater exploded view of components of the CPR mechanism of FIG. 6.

FIG. 8 also shows components of the CPR mechanism of FIG. 6 in a greater exploded view but including components omitted in that earlier figure.

FIGS. 9 to 11 provide exploded views of the stem portion of the CPR mechanism of the prior figures which permit the adjustment of the upper limit traveled by the handles when administering CPR.

FIGS. 12 and 13 contain exploded views of an alternate stem mechanism which differs from that of the prior three figures by allowing the adjustment of the lower limit of travel of the handles during CPR.

FIG. 14 shows in exploded view the belt coupler component of the CPR mechanism of the prior figures.

FIG. 15 illustrates the belt coupler of the CPR mechanism of the prior figures attached to the trolley portion of the mechanism.

FIG. 16 provides a top plan view of the CPR mechanism of the earlier figures.

FIG. 17 shows a CPR mechanism very similar to those of the prior figures but which include data retrieval connections.

FIG. 18 displays in isometric view a CPR device similar to those of the prior figures but which employs one type of an automating mechanism.

FIG. 19 illustrates the components of the automated CPR device of FIG. 19 which allow it operate automatically.

### DETAILED DESCRIPTION

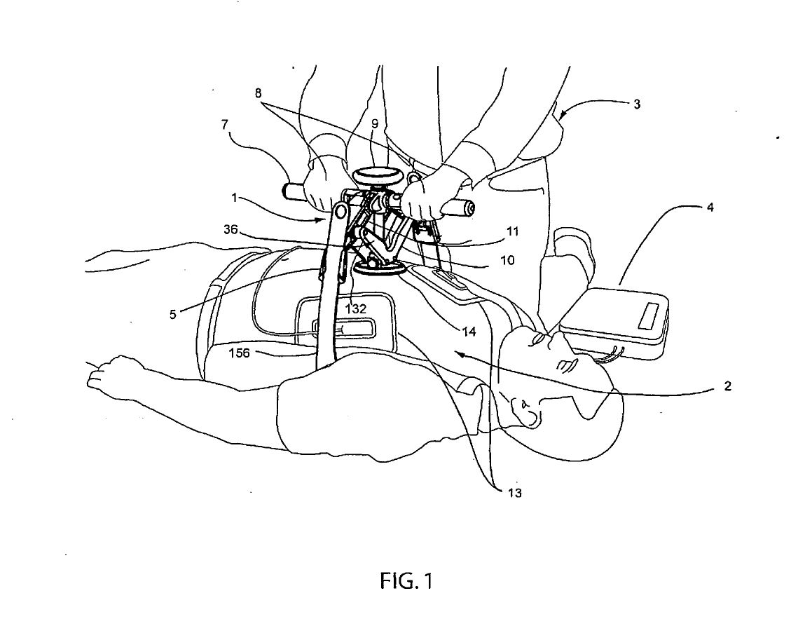

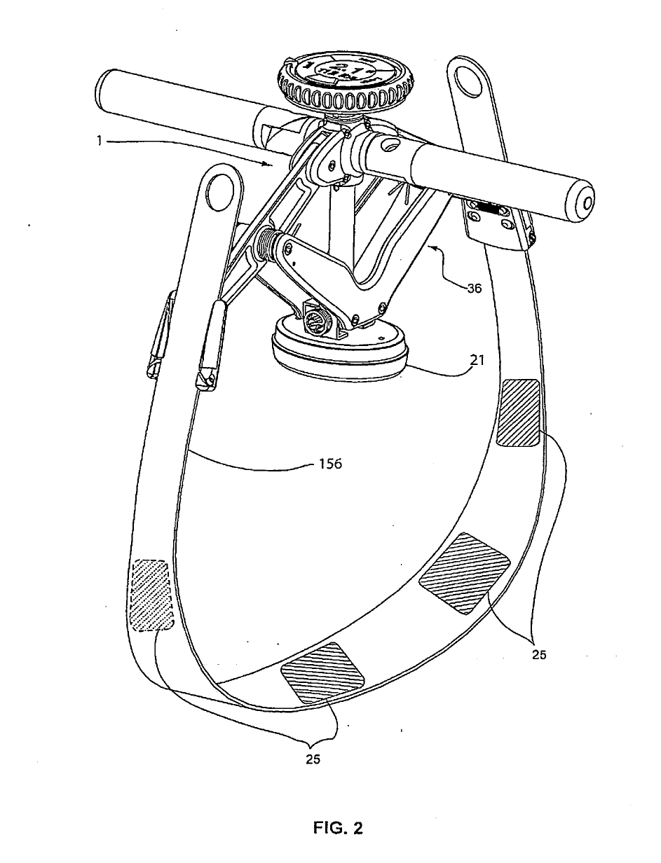

FIG. 1 shows a CPR apparatus generally at 1 sitting on and surrounding the chest 2 of a patient. The base 14 makes contact with the patient's chest and may take the form of a semi-rigid plate or block of plastic, carbon-reinforced plastic or other nonconductive material, or aluminum. It may also have the cushioned outer surface 21 in FIG. 2 contoured to seat against the central region of the patient's chest 2 near the patient's sternum.

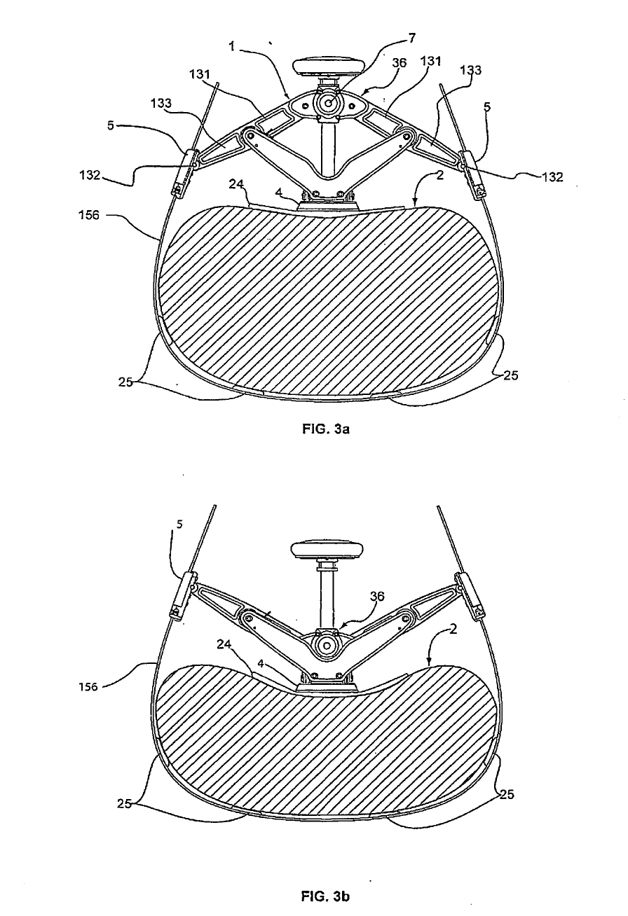

In use the base 14 seats against the upper surface of the chest 2 and may have the adhesive pad 24 in FIGS. 3a and 3b or a suction cup to adhere it to the chest 12. Pulling upward on the apparatus and therefore the base 4 will also pull the chest 12 upward to create active-decompression.

The adhesive pad 24 in FIG. 3a may include an electrode which may have a size larger than the base 4. The adhesive pad 24 with its embedded electrode may find use in combination with one or more electrodes 25 interposed along the length of the belt 6 or with the electrode 33 embedded in the backboard 15. These electrodes may induce a current through the chest to defibrillate a patient's heart.

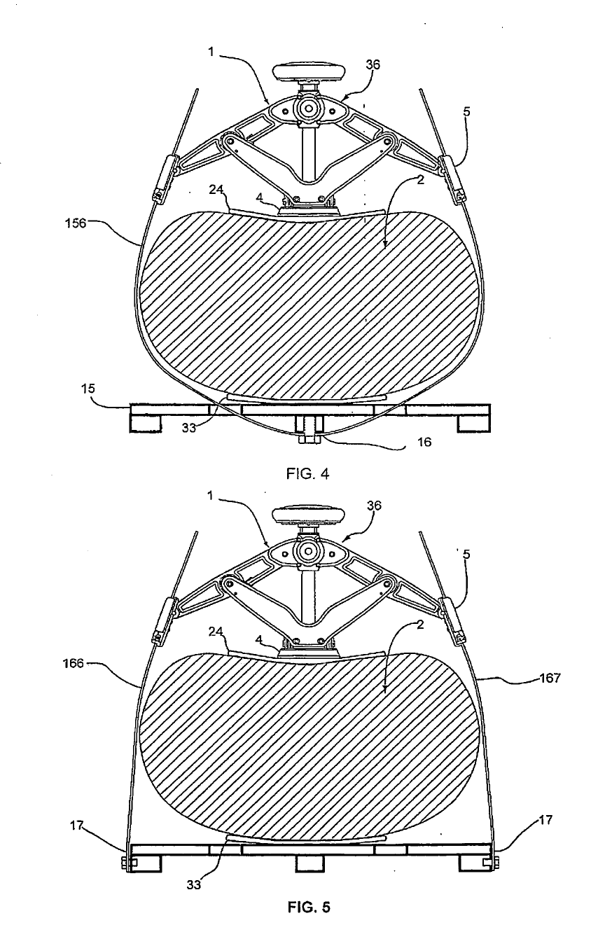

The electrodes 25 may sit at multiple positions along the length of the belt 6 as shown in FIG. 2 as well as in the backboard 15 or 17 of FIGS. 4 and 5, respectively. However, placing an electrode in the base 4 or in the adhesive pad 24 in addition to at least one other electrode proves particularly beneficial. At the furthest, or deepest, compression of the chest, the distance between the chest's anterior and posterior outer surfaces will reach a minimum. At this point, the base will more closely approach the heart than at any other time in the cycle as seen in FIG. 3b. This results in a minimum of resistance to the flow of electrical current. This produces the greatest current flow through the heart with the least likelihood of injuring the patient's chest tissue. Alternatively or additionally to placing the electrodes circumferentially about the chest, they can also sit at the same circumferential location but with a longitudinal spacing from each other.

The operator's hands 8 press down on the two handles 7 attached to the center trolley 36 and arranged parallel to the longitudinal axis of the patient. The handles 8 move in a substantially linear, vertical motion causing the two pivoting arms 11 to rotate around the two pivot points 12. Attaching the two handles 7 to the center trolley 36 helps insure an evenly applied force to the chest to reduce or entirely eliminate any imbalance that could possibly injure to the patient. The trolley 36 may have a composition of a high tensile strength, light weight material such as plastic, aluminum or a composite material

The linear movement of the device 1 maintains the simple vertical motion of CPR with very little loss of energy through rotational motion. It also reduces the tangential, chest encircling movement of the belt ends, thus reducing the thoracic compression to a negligible amount. As a result, this CPR device 1 moves the blood primarily with a direct cardiac compression force.

By cyclically depressing with a downward force and releasing the force and allowing the handles to return to the starting point, the rescuer cyclically compresses and releases the chest in a manner that compresses the heart between the sternum and the spine. This method forces blood out of the heart through one-way valves and, upon release, draws blood back into the heart. Upon each compression, blood is forced out of the heart (and air out of the lungs). Upon release, blood is pulled back in to fill the void created by the discharged fluid. Since the circulatory system has a series of one-way valves, this periodic compression and release of the heart creates an artificial blood pump that supplies necessary nutrients to the vital organs, such as the brain, and increases the patient's chances of survival.

The average person typically has the ability to apply enough force to generate a minimum amount of life-sustaining blood flow. However, most people can perform this repetitive motion, at the desired rate of about 100 beats per minute for only a minute or two. The CPR device 1 can significantly increase the average person's endurance by reducing the peak force required for the task. The device accomplishes this objective by increasing the travel distance of the handles 7 (and thus the operator; hands 8) to achieve the necessary compression.

Typically, the work that a mechanical device achieves equals the applied force times the distance moved. Thus, the force applied to cause a displacement at one end of a lever should equal the product of force and displacement at the opposite end of the lever, or:

$$W = F \times D$$

$$W = \frac{1}{2} F \times 2 D$$

where W stands for work, F equals the applied force, and D represents the distance moved. In the CPR device shown above, the distance of the lever arms 131 in FIG. 3a from the handles 7 to the pivot points 132 (on the belt 6) is double that of the lever arm 133 from the trolley 36 (and thus the base 4) to the pivot points 132. Thus, the handles 7 move twice as far as the base 4 of the trolley 36. By the above equation, this means that the force applied to the chest 2 actually is double that applied to the handles 7.

However this explanation does not prove complete for the present illustrated CPR device. Here, the base 4 does not remain static as the handles 7 move in a downward direction. As seen in the FIGS. 3a and 3b, the base 4 moves into the chest (compressing it) as the downward movement of the handles 7 creates a downward force on it. Stated in other words, the handles 7 “chase” the base 4 as the latter depresses the chest 2. In the device shown in FIGS. 3a and 3b, the base will move a distance that the handles 7 could move in the trolley 36 if the latter remained stationary. However, it does not, In fact, in the arrangement shown, the trolley 36 and the base 4 will move this same distance into the chest (if the patient's anatomy allows it). This results in the handles 7 moving in space double the distance they move in the trolley 36.

The linear, vertical motion of the handle assembly 7 permits a simple and reliable action which virtually any person can effectuate. Doing so requires a small force, and creates a larger (i.e., double in the device shown in the figures) force that is applied to a patient's chest. This force multiplication proves especially beneficial since reducing the peak force required of the rescuer increases his or her endurance to the clear benefit of the patient.

The relative numbers given above depend upon the relative distances of the handles 7 to the pivot point 132 compared to the length of the lever arm 133 for the trolley 36. The multiplier of two proves propitious for this purpose. Other multiplier may work as well or possibly even better. Thus, making the respective lever arms closer to each other in,length than one doubling the other will result in a force multiplier and relative motion factor of less than two. Increasing the disparity in lever arm length above two will similarly increase the relative motion and relative force factor climbing above that number.

The belt 6 may have a composition of a substantially inelastic polypropylene. Other materials will clearly suffice as well for this purpose as long as they have appropriate stiffness and nonstretchability characteristics, The belt 6 attaches to the device 1 at the two belt couplers 5 and extends around the side and back of the chest. It should generally display very little movement during compression. Consequently, the device 1 focuses it compression on the center of the chest. The journalled points 12, attached to the base 4 move in conjunction with the compression of the chest.

FIG. 2 shows a clear view of the apparatus 1 in its starting configuration with regard to the attachment of the belt 6. FIGS. 3a and 3b illustrate the limiting positions of the pivoting arm assemblies 131 and 133 of the present CPR device 1 when installed upon the patient 2. As seen there, the center trolley 36 and the base plate 4 move vertically against the chest 2 to administer CPR. Yet, the belt connections 5 and the belt 6 remain virtually motionless during the CPR.

Preferably, the CPR apparatus 1 should have a construction of a lightweight material. After the patient's chest has undergone compression, any weight resting on the chest will tend to resist decompression once the compression force is removed. Reducing this weight minimizes the amount of unwanted compression during release and the chest's decompression.

Including a full-release indicator with the present CPR apparatus ensures that the patient's chest is permitted to completely expand. This indicator may have some mechanism for alerting the operator when the full release of the tension on the belt has not occurred, or, alternately, when it has happened. This indicator may include, for example, a limit switch such as a magnet reed relay or contacts on the up-stop tabs 50 against which the center trolley 36 rests in the relaxed position.

Alternately, the pivoting arm assemblies 131 may include a mechanism for preventing the application of force to the handles until a full release (and return to the relaxed position) has occurred. A ratchet mechanism having a discreet spacing can find used for this purpose. Crimping tools for loose electrical terminals often include this type of device. As a further choice, a rotational potentiometer may attach to one of the rotation points 132 to measure the position of the arms 133 relative to their starting position.

The belt 6 as shown and described above constitutes a single integral entity extending around the sides and back of the chest. However, it may also include two or more separate component parts such as a belt pair. The components of this belt pair could extend from their attachment to the struts 133 downwardly past the sides of the patient's chest. Each can then rigidly attach to a board, bed, or ambulatory cot which spans all or part of the width of the patient's back. Thus, two or more belt components which extend around portions of the chest circumference in combination with other rigid or flexible components function as a belt for the CPR device. In substance, the belt provides locations relatively fixed in space for the pivot points 132.

Thus, for example; FIG. 4 shows the inelastic belt 156 attached to the center 16 of the backboard 15. Further, FIG. 5 uses the two separate belt sections 166 and 167 attached to the sides of backboard 17. They could also attach to an emergency cot or hospital bed or any other fixed or solid surface for performing CPR. As suggested above, nonetheless, whatever form the belt takes, it may also include one or more defibrillation electrodes

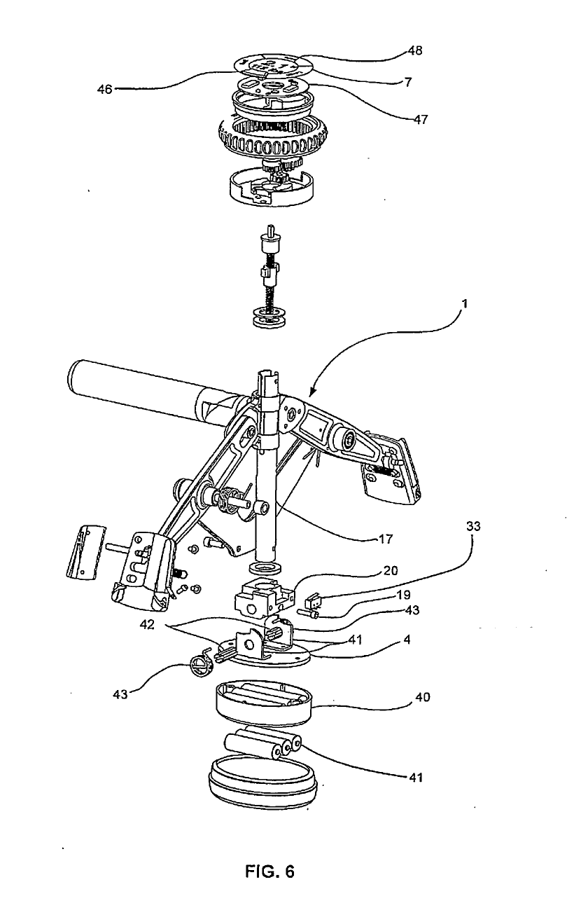

In FIG. 6, the battery compartment 40 contains the three batteries 41 to power a feedback mechanism and the indicators located on the top 48 of the unit, both of which are and controlled by the computer/circuit board 47. The visible LED 46 and audible signals generated by a sound generator on the circuit board 47 provide indications to a rescuer of the moments he or she should provide a force to apply to the apparatus 1 to achieve a desired frequency of CPR compressions. Additionally, voice-generation algorithms could provide verbal instructions to assist the rescuer to set up and operate the device. The LCD screen 48, attached to the dial face 7, displays the depth measurement by using an accelerometer-type distance measuring transducer which may mount on the base or the circuit board. Another method would use a linear encoder which would track the movement of the trolley 36 as it moves up and down the center shaft 17. The shaft 17 may have a composition of a low friction material such as hard anodized aluminum.

The metal pivoting pins 42 rotationally connect the two struts 41, attached to the base 4, to the center block 20 affixed to the center post 17. This allows the base 4 to pivot relative to the center post 17. The struts 41 may have a composition of steel or aluminum, and the center block 20 may be made of aluminum. A strain gauge may measure the deflection on the metal pivot pins 42 to provide an indication of the force exerted on it. The pins 41 allow the base 4 to pivot around the center block 20. The two springs 43, exerting force between the pivoting pins 42 and the two vertical struts 41, bias the base 4 to a perpendicular orientation relative to the shaft 17. The threaded cap screw 19 attaches the center shaft 17 to the center block 20.

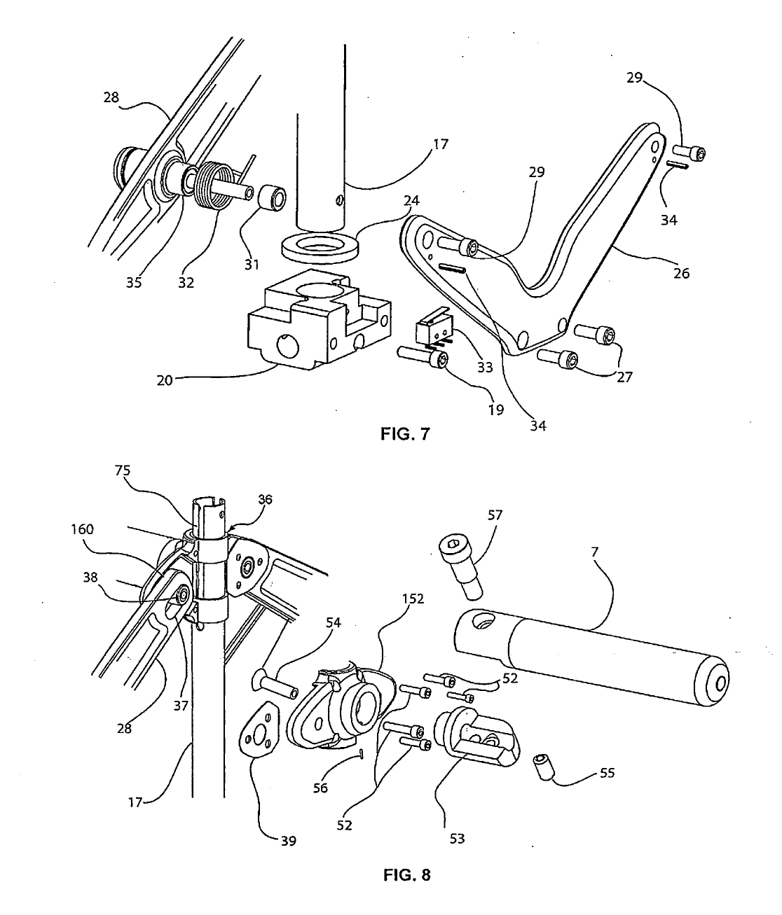

As seen more clearly in FIG. 7, the center shaft 17 passes thru the bottom washer 24 used to dampen the impact of the trolley 36 as it bottoms against the center block 20. The bottoming of the trolley 36 also closes the switch 33 and transmits a signal to the circuit board for processing and recoding the complete movement of a given stroke. The four cap screws 27 attach the two-winged side supports 26 to the center block 20. The wing supports may have a composition of a high tensile strength, light-weight material such as plastic, aluminum or a composite material. The cap screws 29 and the bearings 31 attach the two pivoting arms 28 to the two winged side supports 26. Additionally, the two springs 32, located over the pivoting post 35 which form part of the pivoting arms 28, are tensioned against the spring support post 34 located on the winged side support 26 and on the pivoting arm (not shown).

In FIG. 8, the slot linkage 37 at one end of the pivoting arm 28 sits around the bearing 38 of the center trolley 36. This arrangement permits a sliding motion of the slot 37 of the arm 28 about the bearing 38 as the trolley moves up and down to administer CPR. The trolley 36 uses a low-maintenance bearing sleeve made from a Teflon or similar material to allow its resistance free movement along the center post.

The cap screws 52 attach the plate 39 to the trolley 36 to keep the lever arm end 160 in place. The needle bearing 38 should move freely back and forth inside the machined slot 37 to allow the center trolley 36 free movement of travel up and down the center post 17.

The shoulder bolt 57 attaches the handle 7 to the handle anchor 53 which, in turn, is attached to the center trolley cover 152 with another shoulder bolt 54. This design allows the handle to pivot from a perpendicular position for operation to a parallel position for storage. The ball detent 55 located in the handle anchor 53 controls the handle's rotation into either of these positions. The set screw 56 keeps the handle anchor 53 from rotating during use.

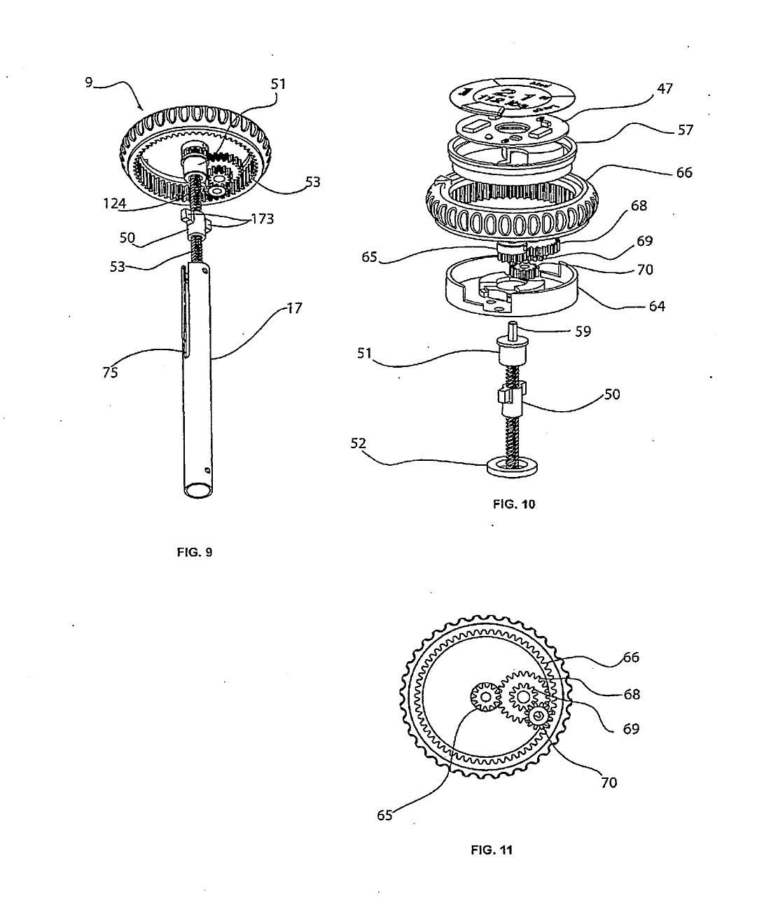

In FIG. 9, the changeable position of the up stop 50 located inside the center post 17 limits the vertical movement of the center trolley 36. The up stop 50 is a threaded metal block that is screwed onto the center spindle 53. The two wings 173 of the up stop 50 that protrude through the two slots 75 located on either side of the center post 17. When the center spindle 174 is rotated, the wings 173 of the up stop 50 sit in the slots 70 and prevent the up stop 50 from rotating. As a consequence, the up stop 50 moves up and down the center spindle 53 to change the length of the CPR stroke

Using a stop to limit the motion of the trolley in the upward direction as opposed to the downward direction may provide two benefits. First, in order to insure the full travel of the trolley, the user of the apparatus should typically push on the handles until the trolley hits bottom. If the adjustment mechanism included an adjustable bottom stop, it would be subjected to repeated collisions between the trolley with the full force of the downward CPR plunge. This force, which is significantly greater than that to move the handles in the upward direction, could ultimately and deleteriously affect the durability of the product.

Second, when pressing on the two pivoting arms, the initial movement of the arms from the full up position requires the use of some of the applied force to overcome the rotation component of the pivot arms in their attachment to the trolley 36 as discussed in FIG. 8 above. In other words, some of the force will find use in overcoming the “over-center” resistance to the downward motion. However, if the up stop actually lowers the uppermost starting position, then the starting point may actually lie tangential or close to tangential, or at the center position, of the arms 28 at the trolley 36. In this case, very little or no force is required to overcome the over-center resistance and virtually all of the applied force serves to move the trolley 36 in the downward direction.

The CPR device 1 may also incorporate a mechanism for storing and suddenly releasing energy during the application of a downward force. The sudden release would be actuated during the withdrawal of the downward force. This mechanism results in the application to the chest of a high intensity force of a short duration rather than a long duration application of force.

FIGS. 9 to 11 display the mechanism that controls the distance traveled by the trolley 36 during CPR. The threaded rod 53 that forms the center spindle moves the up stop 50 one inch for every one third of a circle, or 120 degrees, of rotation. The press fit bearing 51 is seated in the top of the center post 17, is tapered to prevent the center spindle 53 from being lifted out of the assembly, and holds the top of the spindle 53 in place. The center spindle 53 protrudes through the top plate 64 where it is attached by a set screw to a first pinion gear 65. The press-fit bearing 51, seated in the top of the center post 17 and tapered to prevent the center spindle 53 from being lifted out of the assembly, holds the top of the spindle 53 in place.

In FIG. 11, turning the adjustment knob 56 causes the center spindle 53 to rotate to lower or raise the up stop 50. When the attendant rotates the adjustment knob 56, the annular gear on its interior also rotates. That, in turn, rotates the gears 70, which then turns the gear 69. The gear 69 then connects to gear 68, which in turn, rotates the pinion gear 65. The resulting overall gear ratio of this assembly amounts to 5:1. The end result is that 215 degrees of rotation of the knob assembly moves the stop 50 by 1.5 inches. The adjustment knob 66 is held in place by the upper top plate 57. The dial face 7 attaches to the upper surface of the top plate and covers the circuit board 13.

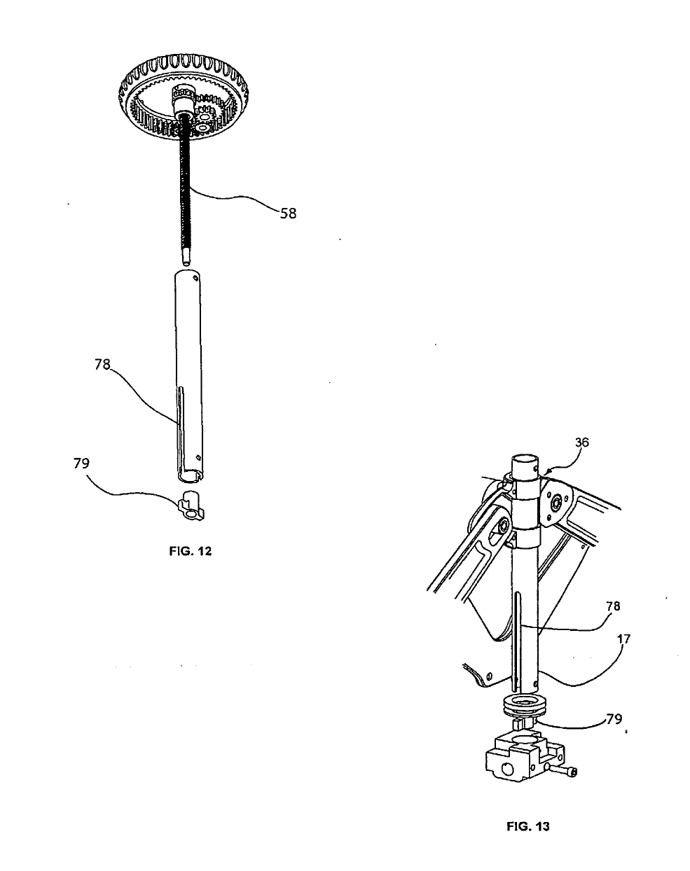

As an alternative to the above, FIGS. 12 and 13 show the components that serve to limit the downward, as opposed to upward, travel of the of the center trolley 36. The center post, in effect, is turned upside down with the result that the machined slot 78 and the stop 79 appear on the bottom of the center post 17, attached to the center block 20. There, the threaded rod 58 extends the full length of the center shaft. 58. FIG. 12 shows the modified assembly integrated with the trolley mechanism 36.

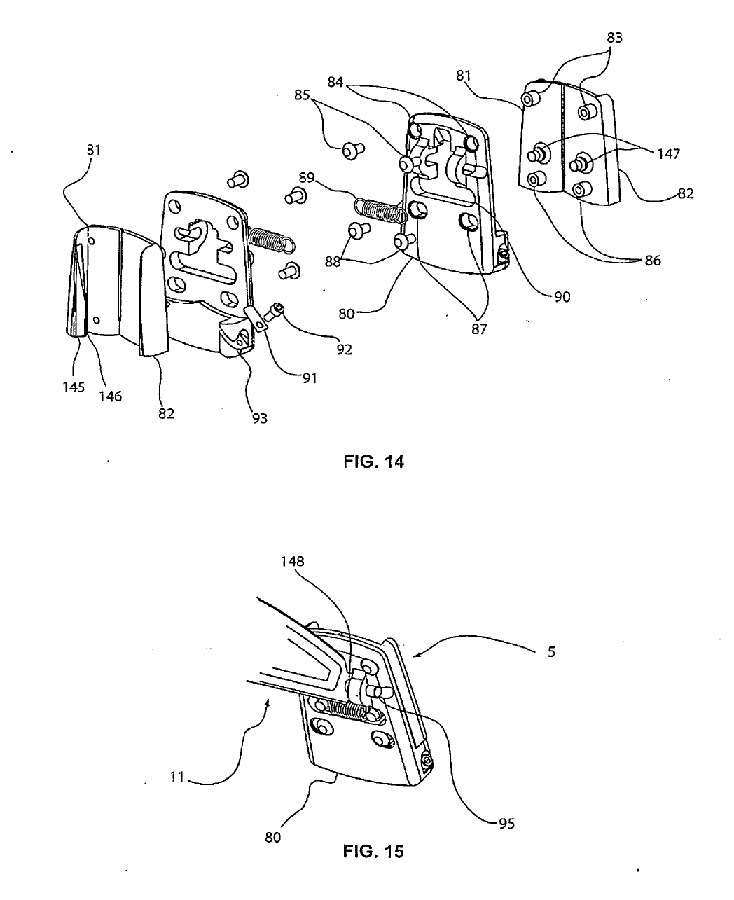

FIGS. 14 and 15 show the belt coupler 5 to which the belt 6 attaches. The coupler 5 includes the machined aluminum back piece 80 and the two symmetrical sliding pieces of polypropylene 81 and 82. The two polypropylene pieces 81 and 82 attach to the back piece 80 with the two posts 83, tightly fit into two holes in the back piece 80, and are secured with the screws 85. The bottom two posts 86 fit into the slots 87 and are loosely secured with the screws 147. The spring 89 attaches to the two posts 88 located in the slot 90 and holds the bottom ends of the two polypropylene sections 81 and 82 together. The two pieces of spring steel 91, one on either side of the back piece 80, are attached to it at a 45 degree angle to the base of the aluminum back piece 80 by the two machined slots 93 held in place by the cap screw 92 and one not seen on the other side. The front edge of each of the polypropylene pieces 81 and 82 is machined to create a tapered edge where the bottom edge 145 overhangs a recessed channel 146. When a belt polypropylene or other suitable composition is pressed into the channel created by the two polypropylene parts 81 and 82, their bottoms ends may separate from each other due to the spring and slot attachment configuration described above. The belt, now confined to the channel between the polypropylene pieces, remains trapped between the two pawls 91 of spring steel which prevent its release. To release the belt, a pulling motion perpendicular to the belt coupler 5 releases the belt from the coupler's grip.

The belt coupler 5 in FIG. 15 attaches to the pivoting arm 11 with the pin 95 which passes through the two mounting holes 148 machined into the aluminum back plate 80. This allows the coupler 5 to pivot to adjust to the angle of the belt 6 traveling around the patient's chest.

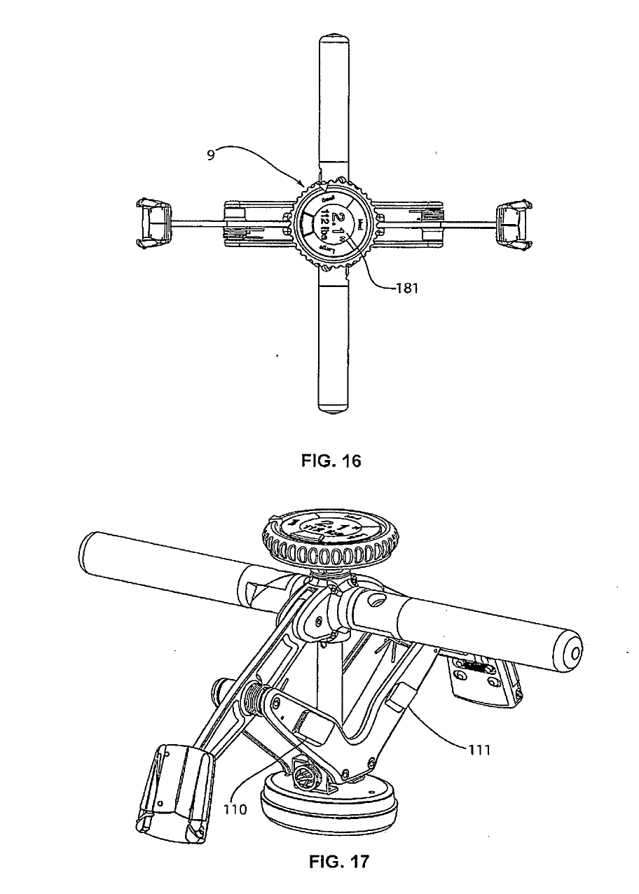

FIG. 16 illustrates the LCD screen 181 located on the top 9 of the unit. There, the applied force, distance traveled, and sizes of Small, Medium and Large are displayed. This dial can read in inches such as 1.5″, 2.0″ and 2.5″ or the equivalent in metric. The weight reading in pounds can also have kilograms.

Two different methods for downloading the data stored on the CPR device appear in FIG. 17. The first takes the form of the SDHC format compact disk reader-writer 110. The other means of communication utilizes the CAT 5 connector 111 or any other that can find use in this application. As a further choice, a wireless communication device such as Bluetooth transmitter could also be included on the circuit board.

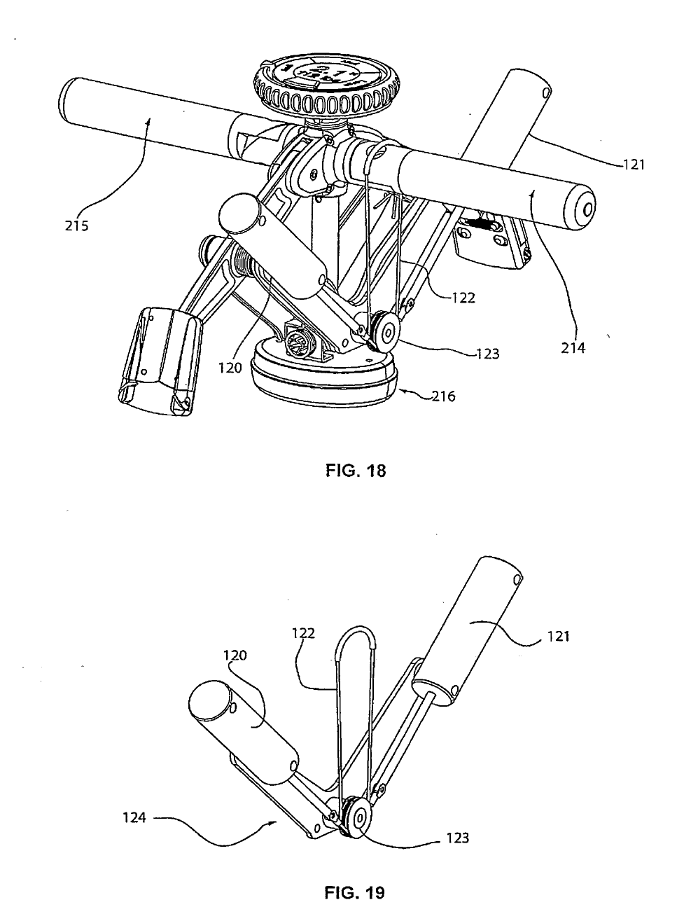

FIGS. 18 and 19 display one method for automating the CPR mechanism. The fluid (hydraulic or pneumatic) cylinders 120 and 121 receiving power from a standard remote source pull on the two ends of the cable 122 attached to the handle mechanism indicated generally at 214 and 215. The cylinders' retracting the cable 122 pulls the handles 214 and 215 towards the base 216, replicating the downward push of a manual compression. The pulley 123 balances and directs the cable in the proper direction. Additionally, the mechanism 124 may constitute a separate attachment that may find use in the presence of a power source. An electric motor might also prove useful. Additionally, some sort of oscillating magnetic system may also find use for this purpose.

The Kelley et al. patents and application and the Lach application show and discuss various additional features of CPR. These may well find use in the devices shown and discussed above.

Accordingly, what is claimed is:

1. A CPR apparatus for increasing the flow of blood in a patient, said apparatus comprising:
A. a base contoured to seat near a central region of a patient's chest;
B. force delivery means coupled to said base;
C. handle means coupled to said force delivery means in a manner that said handle means travels over a range of motion towards and away from said chest;
D. substantially inelastic belt means passing around said patient in the region of said patient's chest and maintaining said base in a position on said patient's chest; and
E. a belt securing assembly coupled to said force delivery means and said belt means for securing said belt means to said force delivery means, said force delivery means, when said handle means moves a distance towards said patient's chest, moving said base towards said chest at an approximately constant fraction of the distance traveled by said handle means over said range of motion, said fraction being unequal to one.

2. The apparatus of claim 1 wherein said fraction is about one half

3. The apparatus of claim 2 wherein force delivery means moves downward when a downward force is applied to handle means.

4. A method of CPR treating a patient comprising:
(A) seating a base of a blood flow increasing apparatus on a patient's chest near a central region of said chest;
(B) moving a handle means coupled to said base over a range of motion towards and away from said chest; and
(C) moving said base towards said chest at an approximately constant fraction of the distance traveled by said handle means over said range of motion, said fraction being unequal to one.

5. The method of claim 4 wherein said fraction is about one half.

6. A CPR apparatus for increasing the flow of blood in a patient, said apparatus comprising:
A. a base contoured to seat near a central region of a patient's chest;
B. force delivery means coupled to said base;
C. handle means coupled to said force delivery means in a manner that said handle means travels over a range of motion towards and away from said chest;
D. substantially inelastic belt means passing around said patient in the region of said patient's chest and maintaining said base in a position on said patient's chest; and
E. a belt securing assembly coupled to said force delivery means and said belt means for securing said belt to said force delivery means,
said force delivery means, upon the application of a first force of a first magnitude to said handle means towards said base, applies a second force of a second magnitude of a substantially constant multiplier of said first magnitude to said base towards said chest over said range of motion of said handle means, said multiplier being unequal to one.

7. The apparatus of claim 6, wherein said multiplier is about 2.

8. A method of CPR treating a patient comprising:
(A) seating a base of a blood flow increasing apparatus on a patient's chest near a central region of said chest;
(B) moving with a first force of a first magnitude a handle means coupled to said base over a range of motion towards and away from said chest; and
(C) applying a second force of a second magnitude to said base in a direction towards said chest, said second magnitude being a substantially constant multiplier of said first magnitude as said handle means over said range of motion towards said base, said multiplier being unequal to one.

9. The method of claim 8, wherein said multiplier is about two.

10. A CPR apparatus for increasing the flow of blood in a patient, said apparatus comprising:
A. a base contoured to seat near a central region of a patient's chest;
B. force delivery means coupled to said base;
C. handle means coupled to said force delivery means in a manner that said handle means travels along a substantially straight line towards and away from said chest;
D. substantially inelastic belt means passing around said patient in the region of said patient's chest and maintaining said base in a position on said patient's chest; and
E. a belt securing assembly coupled to said force delivery means and said belt means for securing said belt to said force delivery means,
said force delivery means, upon the application of a first force of a first magnitude to said handle means towards said base, applies a second force of a substantially constant second magnitude relative to and greater than said first magnitude to said patient base towards said chest.

11. The CPR apparatus of claim 10 further including (a) limiting means, coupled to said handle means, for limiting the distance said handle means travels along said substantially straight line and (b) adjusting means, coupled to said limiting means, for changing said distance.

12. The CPR apparatus of claim 11 wherein said limiting means limits the distance said handle means travels away from said base.

13. The CPR apparatus of claim 1.1 wherein said limiting means limits the distance said handle means travels towards said base.

14. A method of CPR treating a patient comprising:
(A) seating a base of a blood flow increasing apparatus on a patient's chest near a central region of said chest;
(B) moving with a first force of a first magnitude a handle means coupled to said base over a range of motion along a substantially straight line towards and away from said chest; and
(C) applying a second force of a second magnitude to said base in a direction towards said chest, said second magnitude being a substantially constant multiplier of said first magnitude as said handle means over said range of motion towards said base.

15. In a CPR apparatus for increasing the flow of blood in a patient, said apparatus comprising:
A. a base contoured to seat near a central region of a patient's chest;
B. force delivery means coupled to said base for moving said patient contact base towards said chest;
C. connecting means, coupled to said base and to said force delivery means, for retaining said base and said force delivery means adjacent to each other;
D. substantially inelastic belt means passing around said patient in the region of said patient's chest and maintaining said base in a position on said patient's chest; and
E. a belt securing assembly coupled to said force delivery means and said belt means for securing said belt means to said force delivery means,
the improvement wherein said connecting means permits rotational motion between said base and said force delivery means.

16. The improvement of claim 15 wherein said connecting means permits said rotational motion in a plane passing vertically though the longitudinal central axis of said patient's body.

17. A method of CPR treating a patient comprising:
(A) seating a base of a blood flow increasing apparatus on a patient's chest near a central region of said chest, the bottom of said base being contoured to lie substantially flat on said patient's chest;
(B) moving with a first force of a first magnitude a handle means coupled to said base over a range of motion along a substantially straight line in a substantially vertical direction toward and away from said chest;
(C) applying a second force of a second magnitude to said base in a substantially vertical direction towards said chest as said handle means over said range of motion towards said base; and
(D) while said handle moves said over said range of motion in a substantially vertical direction, maintaining said base in contact with said chest with said bottom of said base lying substantially flat on said chest.

18. In a CPR apparatus for increasing the flow of blood in a patient, said apparatus comprising:
A. a base contoured to seat near a central region of a patient's chest;
B. force delivery means coupled to said base;
C. handle means coupled to said force delivery means in a manner that said handle means travels towards and away from said chest;
D. substantially inelastic belt means having first and second ends and passing around said patient in the region of said patient's chest and maintaining said base in a position on said patient's chest; and
E. a belt securing assembly coupled to said force delivery means and said belt means for securing said belt means to said force delivery means,
the improvement wherein said belt securing assembly attaches at any point within a predetermined distance of said first end of said belt means, and, while said belt securing assembly is coupled to said belt means, permits motion of said first end of said belt means in a direction to tighten said belt means around said patient while prohibiting motion of said first end of said belt means in a direction to loosen said belt means around said patient.

19. The improvement of claim 18 wherein said belt means takes the form, near said first end, of a substantially stiff, wide belt and said belt securing assembly has a U-shaped configuration which allows said first end of said belt means to enter the opening of said U shape and, when said first end of said belt means has entered the opening of said U shape, prohibits said first end from moving in said direction to loosen said belt means around said patient.

20. The improvement of claim 19 wherein said belt securing assembly includes gripping means on at least one side of and coupled to said U shape for preventing movement of said belt means in the direction to loosen said belt means around said patient but allowing movement of said belt means in the direction to tighten said belt means around said patient.

21. The improvement of claim 19 wherein said belt securing assembly has a pivoting coupling said force delivery means

22. A method of CPR treating a patient comprising:
(A) seating a base of a blood flow increasing apparatus on a patient's chest near a central region of said chest, said apparatus including a belt securing assembly for securing a belt means to said apparatus;
(B) placing a belt means under said patient with one end of said belt means unattached to said apparatus;
(C) attaching said belt securing assembly at any point within a predetermined distance of said first end of said belt means while said belt means is under said patient; and
(D) while said belt securing assembly is coupled to said first end of said belt means, moving said first end of said belt means in a direction to tighten said belt means around said patient while prohibiting motion of said first end of said belt means in a direction to loosen said belt means around said patient.

23. The method of claim 22 wherein said belt means takes the form, near said first end, of a substantially stiff, wide belt and said belt securing assembly has a U-shaped configuration which allows said first end of said belt means to enter the opening of said U shape and, the attaching of said end of said belt means is accomplished by placing said first end of said belt means into the opening of said U shape and the tightening of said belt means is accomplished by pulling said first end of said belt means in a direction away from said patient while said first end of said belt means remains within said opening of said U shape.

24. A CPR apparatus for increasing the flow of blood in a patient, said apparatus comprising:
A. a base contoured to seat near a central region of a patient's chest;
B. force delivery means coupled to said base;
C. handle means coupled to said force delivery means in a manner that said handle means travels over a range of motion towards and away from said chest;
D. substantially inelastic belt means passing around said patient in the region of said patient's chest and maintaining said base in a position on said patient's chest; and
E. a belt securing assembly coupled to said force delivery means and said belt means for securing said belt to said force delivery means,
said force delivery means, upon the application of a first force of a first magnitude to said handle means towards said base, applies a second force substantially parallel to said first force and of a second magnitude greater than said first magnitude and directed to said base towards said chest over said range of motion of said handle means.

25. A CPR apparatus for increasing the flow of blood in a patient, said apparatus comprising:
A. a base contoured to seat near a central region of a patient's chest;
B. force delivery means coupled to said base;
C. handle means coupled to said force delivery means in a manner that said handle means travels over a range of motion towards and away from said chest;
D. substantially inelastic belt means passing around said patient in the region of said patient's chest and maintaining said base in a position on said patient's chest; and
E. a belt securing assembly coupled to said force delivery means and said belt means for securing said belt to said force delivery means,
said force delivery means, upon the application of a first force of a first magnitude to said handle means towards said base, applies a second force having a resultant vector direction substantially parallel to said first force and of a second magnitude greater than said first magnitude and directed to said base towards said chest over said range of motion of said handle means.

26. A method of CPR treating a patient comprising:
(A) seating a base of a blood flow increasing apparatus on a patient's chest near a central region of said chest;
(B) moving with a first force of a first magnitude a handle means coupled to said base over a range of motion towards and away from said chest; and
(C) applying a second force having a resultant vector direction substantially parallel to said first force and of a second magnitude greater than said first magnitude and directed to said base towards said chest over said range of motion.
